(19) United States
(12) Patent Application Publication
(10) Pub. No.: US 2010/0137525 A1
(43) Pub. Date: Jun. 3, 2010

(54) Catalyst composition for hydrogenation and their use for hydrogenation conjugated diene polymer

(75) Inventors: Kuei-Lun Chen, TAICHUNG (TW); Chen-Pao Huang, TAICHUNG (TW)

Correspondence Address: Kuei-Lun Chen, P. O. BOX 55-124, TAICHUNG, TW

(73) Assignee: CHI-MEI CORPORATION

(21) Appl. No.: 12/656,478

(22) Filed: Feb. 1, 2010

Related U.S. Application Data
(63) Continuation-in-part of application No. 11/987,224, filed on Nov. 28, 2007.

(51) Int. Cl. C08F 136/06; C08F 136/08

(52) U.S. Cl. 525/333.1; 525/331.9; 525/333.2

(57) ABSTRACT

The present invention provides a process for hydrogenation of a conjugated diene polymer comprising hydrogenating said polymer in the presence of hydrogen and a hydrogenation catalyst composition, wherein the catalyst composition comprising a titanium compound (A), a silyl hydride (B) selected from the group having a Si—H group and consisting of a monomeric silyl hydride, a polymeric silyl hydride, and a cyclic silyl hydride; and a compound (C), and conducting the hydrogenation in a middle to larger sized reactor having a capacity of 25 liters, with a temperature of 50° C. to 150° C., and a hydrogen pressure of 1 kg/cm² to 20 kg/cm².

### CROSS REFERENCE TO RELATED APPLICATION

This a Continuation-in-Part application Ser. No. 11/987,224, filed on 28 Nov. 2007.

### BACKGROUND OF THE INVENTION

1. Field of the Invention

The present invention relates to a catalyst composition for hydrogenation, and more particularly to a process for hydrogenation of a conjugated diene polymer.

2. Description of the Prior Arts

The utilization of conjugated dienes (e.g. butadiene, isoprene) in polymerization or co-polymerization reactions for preparing synthetic rubbers has been widely used in industry production. Basically, these polymers can be prepared by either emulsion or solution processes. Both processes give conjugated diene polymers (copolymers) containing unsaturated double bonds in the polymer backbone. These unsaturated double bonds can be further utilized for vulcanization to improve the toughness of the material. However, these unsaturated double bonds are vulnerable toward oxidation caused disadvantages of the material in that they lack the stability at elevated temperature or under weathering (exposure to ozone, daylight or ultra violet light).

This deficiency in thermal and weathering stability can be improved by reducing the number of the unsaturated double bonds in the polymer chain through hydrogenation. Technically, applying bis(cyclopentadienyl) titanium as a homogeneous catalyst for hydrogenation the conjugated diene polymer is an effect method.

Though a catalyst composition mainly containing bis(cyclopentadienyl) titanium performs good activity and superior selectivity in hydrogenate double bonds of olefin, however, an alkyl metal such as alkyl aluminum, is required to activate bis(cyclopentadienyl) titanium, or the catalyst composition of bis(cyclopentadienyl) titanium has to be provided in a high concentration. Consequently, such method is uneconomical. In addition, Ti(IV) of bis(cyclopentadienyl) titanium may be reduced into Ti(III) by excessive aluminum and thus lower activity and stability of the catalyst composition. Therefore, it's necessary to modify such catalyst composition.

In U.S. Pat. No. 6,313,230 discloses a catalyst composition for hydrogenating the conjugated diene polymer, which primarily includes a bis(cyclopentadienyl) titanium and a siloxane compound. The catalyst composition also performs good activity and high selectivity for hydrogenation, however, it's not suitable for commercial production due to its poor activity when hydrogenation of the unsaturated double bonds of the polymer is conducted in a middle or large sized reactor (for example, 25 liters or larger), and particularly due to the remarkable reduction of catalyst activity at the end of the reaction. As a result, the polymers can not be, well hydrogenated, i.e., hydrogenation conversion is less than 90%.

Additionally, In U.S. Pat. No. 6,881,797 also discloses a catalyst composition for hydrogenating the conjugated diene polymer. This composition primarily includes a bis(cyclopentadienyl) titanium, a trialkyl aluminum and a compound of formula (I):

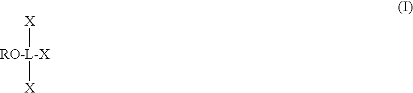

wherein L is an element of the IVB family, R is an alkyl or cycloalkyl group of C₁˜C₁₂, X can be the same or different and is an alkyl, alkoxy or cycloalkoxy group of C₁˜C₁₂, a halogen atom or a carbonyl group. This catalyst composition for hydrogenation also performs good activity and reproducibility, but it requires a higher operation pressure (hydrogen gas) and thus increases the cost for equipment. In addition, the conjugated diene polymer after hydrogenation has some unpleasant smells odor, and the hydrogenation conversion is only about 80%. In the case of a middle or large sized reactor, activity at the end of hydrogenation is even lower, and thus hydrogenation conversion is still unsatisfactory.

Therefore, it's necessary to develop a catalyst composition which is suitable for middle or large sized reactor, with high hydrogenation conversion, good thermal stability, and weather resistance and lower costs.

### SUMMARY OF THE INVENTION

In order to diminish the above demerits of the traditional catalyst compositions, the present invention provides a catalyst composition suitable for hydrogenating the conjugated diene polymer. Further, the conjugated diene polymers produced through the hydrogenation process and catalyst compositions of the present invention perform good thermal stability and are odorless. In addition, the catalyst composition for hydrogenation can maintain activity longer and improve hydrogenation conversion of the polymer, particularly the hydrogenation of the trans structure in the conjugated diene polymer. That is, less residual trans structure of the conjugated diene polymer remains after hydrogenation.

Accordingly, the first object of the present invention is to provide a catalyst composition for hydrogenation which comprises:

(1) a titanium compound (A) represented by the following formula (a):

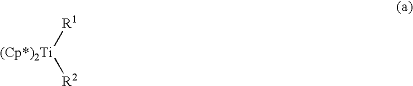

wherein R¹ and R², which may be the same or different, represent a halogen atom, an alkyl group, an aryl group, an aralkyl group, a cycloalkyl group, an aryloxy group, an alkoxy group or a carbonyl group, and Cp* represents a cyclopentadienyl group or a derivative having the formula of C₅R³₅, and R³, which may be the same or different, represents a hydrogen atom, an alkyl group, an aralkyl group and an aryl group;
(2) a silyl hydride (B) selected from the following compounds having a Si—H:

(i) a monomeric silyl hydride represented by the following formula (b):

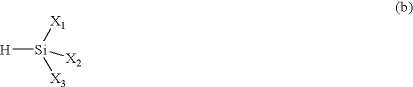

wherein X₁, X₂ and X₃ which may be the same or different, represent a hydrogen atom, a halogen atom, an alkyl group, an aryl group, an aralkyl group, a cycloalkyl group, an aryloxy group, an alkoxy group, an acyloxy group or a carboxylate group;

(ii) a polymeric silyl hydride represented by the following formula (c):

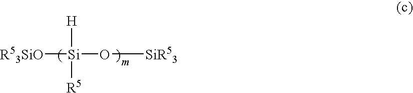

wherein each R⁵ can be the same or different and is selected from the group consisting of a hydrogen atom, a halogen atom, an alkyl group, an aryl group, an aralkyl group, a cycloalkyl group, an aryloxy group and an alkoxy group and m≧0;

(iii) a cyclic silyl hydride represented by the following formula (d):

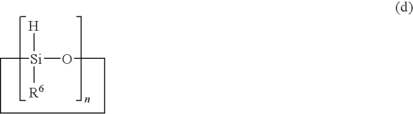

wherein R⁶ represent a hydrogen atom, a halogen atom, an alkyl group, an aryl group, an aralkyl group, a cycloalkyl group, an aryloxy group or an alkoxy group and n=2, 3, 4 or 5; and
(3) a compound (C) represented by the following formula (e):

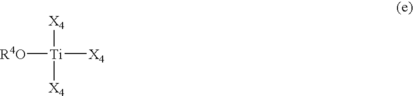

wherein R⁴ is an alkyl group of C₁˜C₁₂ or a cycloalkyl group of C₁˜C₁₂, X₄ can be the same or different and is an alkyl group of C₁˜C₁₂, an alkoxy group of C₁˜C₁₂, cycloalkoxy group of C₁˜C₁₂, a halogen atom or a carbonyl group.

The second object of the present invention is to apply the catalyst composition of the present invention to hydrogenation so as to obtain hydrogenated conjugated diene polymer.

As the catalyst composition for hydrogenation of the present invention comprises the silyl hydride (B) and the compound (C), it's satisfying in hydrogenation conversion, thermal stability and weather resistance when applying to middle or large sized reactors. It better to provide the catalyst composition for hydrogenation of the present invention without organic aluminum compound, and therefore equipment for removing the aluminum compound is not required and the cost can be reduced.

### DETAILED DESCRIPTION OF THE PREFERRED EMBODIMENTS

The catalyst composition for hydrogenation of the present invention comprises a titanium compound (A) having a cyclopentadienyl group, a silyl hydride (B) and a compound (C).

In the present invention, the titanium compound (A) having a cyclopentadienyl group can be represented by the formula (a):

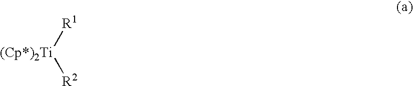

wherein R¹ and R², which may be the same or different, represent a halogen atom, an alkyl group, an aryl group, an arakyl group, a cycloalkyl group, an aryloxy group, an alkoxy group or a carbonyl group, and Cp* represents a cyclopentadienyl group or a derivative having the formula of C₅R³₅, and R³, which may be the same or different, represents a hydrogen atom, an alkyl group, an aralkyl group and an aryl group. Suitable examples of Cp* includes a cyclopentadienyl group and a pentamethyl cyclopentadienyl group. In consideration of industrial application, the cyclopentadienyl group is preferred for Cp*.

Preferably, the titanium compound (A) having the cyclopentadienyl group is selected from bis(cyclopentadienyl) titanium dichloride, bis(cyclopentadienyl) titanium dibromide, bis(cyclopentadienyl) titanium diiodide, bis(cyclopentadienyl) titanium difluoride, bis(cyclopentadienyl) titanium dicarbonyl, bis(cyclopentadienyl) titanium dimethyl, bis(cyclopentadienyl) titanium diethyl, bis(cyclopentadienyl) titanium dipropyl (including isopropyl), bis(cyclopentadienyl) titanium dibutyl (including n-butyl, sec-butyl, tert-butyl), bis(cyclopentadienyl) titanium dibenzyl, bis(cyclopentadienyl) titanium diphenyl, bis(cyclopentadienyl) titanium dimethoxide, bis(cyclopentadienyl) titanium diethoxide, bis(cyclopentadienyl) titanium dipropoxide, bis(cyclopentadienyl) titanium dibutoxide, bis(cyclopentadienyl) titanium diphenoxide, bis(cyclopentadienyl) titanium methyl chloride, bis(cyclopentadienyl) titanium methyl bromide, bis(cyclopentadienyl) titaniumn methyl iodide, bis(cyclopentadienyl) titanium methyl fluoride, and a mixture thereof.

In the present invention, the silyl hydride (B) is selected from the following compounds having a Si—H group:

(i) a monomeric silyl hydride represented by the following formula (b):

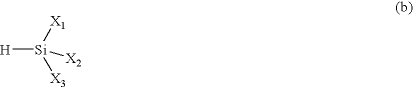

wherein X₁, X₂ and X₃ which may be the same or different, represent a hydrogen atom, a halogen atom, an alkyl group, an aryl group, an aralkyl group, a cycloalkyl group, an aryloxy group, an alkoxy group, an acyloxy group or a carboxylate group,

(ii) a polymeric silyl hydride represented by the following formula (c):

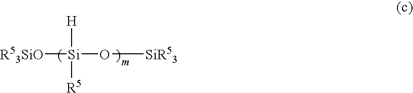

wherein each R⁵ can be the same or different and is selected from the group consisting of a hydrogen atom, a halogen atom, an alkyl group, an aryl group, an aralkyl group, a cycloalkyl group, an aryloxy group and an alkoxy group and m≧0;

(iii) a cyclic silyl hydride represented by the following formula (d):

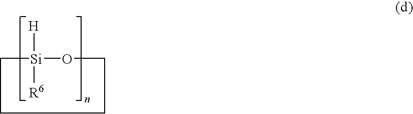

wherein R⁶ represent a hydrogen atom, a halogen atom, an alkyl group, an aryl group, an aralkyl group, a cycloalkyl group, an aryloxy group or an alkoxy group and n=2, 3, 4 or 5.

Preferably, the monomeric silyl hydride of formula (b) is selected from the group consisting of methyl dichlorosilane, ethyl dichlorosilane, propyl dichlorosilane, butyl dichlorosilane, phenyl dichlorosilane, dimethyl chlorosilane, diethyl chlorosilane, dipropyl chlorosilane, dibutyl chlorosilane, diphenyl chlorosilane, dimethyl methoxy silane, dimethyl ethoxy silane, dimethyl propoxy silane, dimethyl butoxy silane, dimethyl benzoxy silane, diethyl ethoxy silane, diethyl ethoxy silane, diethyl propoxy silane, diethyl butoxy silane, diethyl benzoxy silane, dipropyl methoxy silane, dipropyl ethoxy silane, dipropyl propoxy silane, dipropyl butoxy silane, dipropyl benzoxy silane, dibutyl methoxy silane, dibutyl ethoxy silane, dibutyl propoxy silane, dibutyl butoxy silane, dibutyl benzoxy silane, diphenyl methoxy silane, diphenyl ethoxy silane, diphenyl propoxy silane, diphenyl butoxy silane, diphenyl benzoxy silane, dimethylsilane, diethylsilane, dipropylsilane, dibutylsilane, diphyenylsilane, diphenylmethylsilane, diphenylethylsilane, diphenylpropylsilane, diphenylbutylsilane, trimethylsilane, triethylsilane, tripropylsilane, tributylsilane, triphenylsilane, methylsilane, ethylsilane, propylsilane, butylsilane, phenylsilane and methyldiacetoxysilane.

In the above formula (c), m≧0, and preferably ranges between 1 and 100. Preferred examples of the polymeric silyl hydride of formula (c) include polymethylhydrosiloxane, polyethylhydrosiloxane, polypropylhydrosiloxane, polybutylhydrosiloxane, polyphenylhydrosiloxane and 1,1,3,3-tetramethyldisiloxane.

Preferably, examples of the cyclic silyl hydride of formula (d) include methylhydrocyclosiloxane, ethyllhydrocyclosiloxane, propylhydrocyclosiloxane, butylhydrocyclosiloxane, and phenylhydrocyclosiloxane.

In the present invention, the compound (C) is represented by the following formula (e):

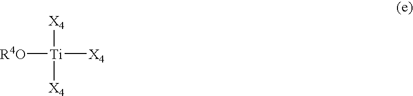

wherein R⁴ is an alkyl group of C₁˜C₁₂ or a cycloclkyl group of C₁˜C₁₂, X₄ can be the same or different and is an alkyl group of C₁˜C₁₂, an alkoxy group of C₁˜C₁₂, cycloalkoxy group of C₁˜C₁₂, a halogen atom or a carbonyl group.

Preferably, the compound (C) is a titanium compound having an alkoxy group without cyclopetadienyl group. Examples of the compound (C) includes: titanium(IV) ethoxide, titanium(IV)n-propoxide, titanium(IV) isopropoxide (TPT), titanium(IV)n-butoxide (TnBT), titanium(IV)sec-butoxide, titanium(IV)isobutoxide, titanium(IV)n-pentoxide, titanium(IV)isopentoxide, titanium(IV)1-methylbutoxide, titanium(IV)2-methylbutoxide, titanium(IV)1,2-dimethylbutoxide, titanium(IV)neopentoxide, titanium(IV)n-hexoxide, titanium(IV) isohexoxide, titanium(IV)1,1-dimethylbutoxide, titanium(IV) 2,2-dimethylbutoxide, titanium(IV) 3,3-dimethylbutoxide, titanium(IV)n-dodecoxide, etc.

In the present invention, the catalyst composition for hydrogenation can comprise a metal compound (D) optionally, for example, an organic lithium compound, an organic aluminum compound, an organic magnesium compound, an organic zinc compound, a LiH or LiOR′ compound (R′=alkyl, aryl, aralkyl or cycloalkyl). Examples of the above organic lithium compound include: n-propyl lithium, iso-propyl lithium, n-butyl lithium, sec-butyl lithium, tert-butyl lithium, n-pentyl lithium, a dilithium compound, and an anionic active polymer having active lithium thereon. Examples of the above organic magnesium compound include dimethyl magnesium, diethyl magnesium, methyl magnesium bromide, methyl magnesium chloride, ethyl magnesium bromide, ethyl magnesium chloride, phenyl magnesium bromide, phenyl magnesium chloride. Examples of the above organic zinc compound include diethyl zinc, bis(cyclopentadienyl) zinc, and diphenyl zinc. Examples of the above LiOR′ compound include lithium methoxide, lithium ethoxide, lithium n-propoxide, lithium isopropoxide, lithium n-butoxide, lithium sec-butoxide, lithium tert-butoxide, lithium pentoxide, lithium hexoxide, lithium heptoxide, lithium octoxide, lithium phenoxide, 4-methyl lithium phenoxide, and 2,6-di-t-butyl-4-methyl lithium phenoxide.

In the present invention, It is better to provide the catalyst composition of the present invention without an organic aluminum compound to obtain good thermal stability and odorless hydrogenated polymer. Alternatively, the organic aluminum compound can be added and after hydrogenation, the hydrogenated conjugated diene polymer is washed with an acid/water to remove the residue of the organic aluminum compound. Examples of the organic aluminum compound include: trimethyl aluminum, triethyl aluminum, triisobutyl aluminum, triphenyl aluminum, diethylaluminum chloride, ethyl aluminum dichloride, methylaluminium sesquichloride, ethylaluminum sesquichloride, diethylaluminum hydride, diisobutylaluminum hydride, triphenyl aluminum, and tri(2-ethylhexyl) aluminum, etc.

During hydrogenation with the catalyst composition of the present invention, the titanium compound (A) is generally presented in the concentration within a range of about 0.0002˜20 millimoles per 100 grams of polymer, preferably from 0.001˜10 millimoles, more preferably from 0.001˜2 millimoles. The mole ratio of the silyl hydride (B) to the titanium compound (A) is generally within a range of 0.01˜200, preferably from 0.1˜100, and more preferably from 0.2˜30. The mole ratio of the compound (C) to the titanium compound (A) is generally within a range of about 0.01˜50, preferably from 0.1˜30, more preferably from 0.5˜16. The mole ratio of the compound (C) to the silyl hydride (B) is generally within a range of about 0.01˜200, preferably from 0.5˜150, and more preferably from 1˜100. Within the above ranges, the catalyst composition for hydrogenation can provide a high hydrogenation conversion of the hydrogenated conjugated diene polymer, and particularly less residual of trans structure of the hydrogenated conjugated diene polymer with odorless and good thermal stability. In addition, the mole ratio of the metal compound (D) to titanium compound (A) generally ranges within 0˜100, and preferably within 0˜25.

When applied to middle to large sized reactor (for example, 25 liters or larger) for hydrogenating the conjugated diene polymer, the catalyst composition of the present invention can exhibit good catalyst activity and achieve well-hydrogenated conjugated diene polymer. The catalyst composition of the present invention can be operated under middle-to-low hydrogen pressure (for example, below 12 kg/cm²) and achieve well-hydrogenated conjugated diene polymer. These features are very advantageous in equipment investment and operation of the production.

The catalyst composition for hydrogenation of the present invention can be applied to conjugated diene polymer which includes homopolymer or copolymer of 1,3-butadiene and/or isoprene, for example, the homopolymer of conjugated diene, the copolymer of different conjugated diene, and copolymer of at least a conjugated diene and at least an olefin monomer.

The number average molecular weight of the conjugated diene polymer suitable to be hydrogenated by the catalyst composition of the present invention ranges within 500˜1,000,000, preferably 1,000˜750,000, and more preferably 10,000˜500,000.

During polymerization of the conjugated diene polymer, a free radical or an anionic catalyst can be applied to polymerization by a bulk, a solution or an emulsion method. In general, the anionic solution method for polymerization of the conjugated diene polymer includes steps of adding monomers altogether or in sequence, and then adding a proper amount of a solvent, an anionic polymeric initiator and other additives into a reactor to form a living polymer. The living polymer comprises a lithium at one end thereof, and therefore can polymerize with monomers to achieve a long-chain polymer. The above reactor may be equipped with a jacket and an agitator. The above anionic polymeric initiator can be alkyls, amides, silanolates, bisphenyls or anthracenyl derivatives of the metal of the IA family (for example, an organic lithium compound), for example, n-propyl lithium, isopropyl lithium, n-butyl lithium, sec-butyl lithium, tert-butyl lithium, n-pentyl lithium, a dilithium compound, and an anionic active polymer having active lithium thereon. Examples of the solvent for polymerization include a straight-chain alkane such as heptane, octane, etc., and alkyl substituted derivatives thereof; a cycloaliphatic compound such as cyclopentane, cyclohexane, cycloheptane, and alkyl and aryl substituted derivatives thereof; aryl and alkyl substituted aryl compounds such as benzene, toluene, xylene and derivatives thereof; linear and cycloether such as dimethyl ether, methyl ethyl ether, diethyl ether, tetrahydrofuran, and derivatives thereof. The above conjugated diene polymer can be reacted at a temperature ranging from −150° C. to 300° C., and preferably from 0° C. to 100° C.

The conjugated dienes used in the production of these conjugated diene polymers are generally those having 4 to about 12 carbon atoms. Specific examples thereof are 1,3-butadiene, isoprene, 2,3-dimethyl-1,3-butadiene, 1,3-pentadiene, 2-methyl-1,3-pentadiene, 1,3-hexadiene and 4,5-diethyl-1,3-butadiene, wherein 1,3-butadiene and isoprene are particularly preferred in view of advantages in industrial application and of excellent properties of elastomers obtained. Examples of the olefin monomer for copolymerizing with the conjugated diene include styrene, t-butylstyrene, α-methylstyrene, p-methylstyrene, divinylbenzene, 1,1-diphenylethylene, N,N-dimethyl-p-aminoethyletyrene, N,N-diethyl-p-aminoethylstyrene, etc. Of these, styrene is particularly preferred. Examples of the copolymers of a conjugated diene and a vinyl-substituted aromatic hydrocarbon include a butadiene/styrene copolymer and an isoprene/styrene copolymer, and these two copolymers are the most preferable because they provide hydrogenated copolymers of high industrial value.

The above conjugated diene polymer may include a random structure, a tapered structure, a block structure, or a grafted structure.

The block copolymers may be linear type, branch type, radial type or star type. In the present invention, the block copolymers preferably includes 5 wt. %˜95 wt. % of the vinyl aryl compound. When the block copolymers as required are hydrogenated, the olefin part thereof possesses good elasticity, and therefore it's not only useful for industrial application, but also easily separated from the solvent due to low viscosity thereof. Accordingly, a hydrogenated block copolymers can be easily produced.

In the present invention, hydrogenation of the conjugated diene polymer is carried out with the catalyst composition and a hydrogen gas in a solvent. The temperature for hydrogenation is controlled within 0° C.˜200° C., and preferably 50° C.˜150° C.; the hydrogen pressure is controlled within 0.1 kg/cm²˜50 kg/cm², preferably 1 kg/cm²˜20 kg/cm², and more preferably 1 kg/cm²˜12 kg/cm²; and the contact time (hydrogenation) may be within 1 min˜40 hrs, and preferably 10 min˜10 hrs. The hydrogen gas can be added after the polymerization of the conjugated diene polymer, or accompanied with the catalyst composition. Alternatively, the hydrogen gas can be continuously added with the polymer solution in a continuous process.

In the present invention, the compounds (A), (B), (C) and (D) of the catalyst composition can be added into conjugated diene polymer solution individually, or at least two of these compounds be pre-mixed before adding into conjugated diene polymer solution. Alternatively, these components of the catalyst composition can be previously dissolved in a solvent to form a catalyst composition solution, wherein the solvent can be the same as the solvent used for polymerization of the conjugated diene polymer.

Reaction may be carried out in stirred tank reactors or in loop-reactors or packing-tower reactors in which the solution mixture to be hydrogenated may be optionally extracted from the reactor and circulated by means of a pump through a heat exchanger and reintroduced into the reactor where it is contacted with hydrogen. The reaction may be carried out in a continuous or batch-type operation, by a bulk or solution method. For the solution method, an inert solvent used in the anionic polymerization can be directly used without additional purification. In general, all solvents used in known processes for preparing the conjugated diene polymer are suitable and mentioned in the above.

After the hydrogenation reaction, the reaction solution can be quenched with an alcohol (e.g. methanol, ethanol or isopropanol) to precipitate the desired hydrogenation polymer. The resulting polymer product can then be collected by filtration and dried in vacuum to give the desired product in high purity. The polymer of the present invention also can be obtained with a devolatilizer, for example, a vacuum devolatilizer or a devolatilizing extruder. Noted that because of the high reactive nature of the invention catalyst system, only small amount of catalyst species is used in the hydrogenation reaction, thereby additional washing process for removing catalyst component is not required.

When hydrogenation occurs in a middle or large sized reactor, in the case of a homopolymer of the conjugated diene polymers, a hydrogenation conversion of at least 50%, preferably at least 70%, and more preferably at least 90% of the unsaturated double bonds of conjugated diene units can be obtained. In the case of a copolymer of a conjugated diene and a vinyl-substituted aromatic hydrocarbon, a hydrogenation conversion of at least 50%, preferably at least 70%, and more preferably at least 90%, of the unsaturated double bonds of the conjugated diene units of the original copolymer and 10% or less, preferably 5% or less, and more preferably 3% or less, of the double bonds of the aromatic portions of the original copolymer have been selectively hydrogenated.

The hydrogenation conversion of the unsaturated double bonds of the conjugated dienes can be determined from an infrared absorption spectrum. In the case of a polymer containing aromatic rings, an ultraviolet absorption spectrum, an NMR spectrum, or the like can be used in combination therewith.

The present invention will now be described more specifically with reference to the following examples. It is to be noted that the following descriptions of examples, including the preferred embodiment of this invention, are presented herein for purposes of illustration and description, and are not intended to be exhaustive or to limit the invention to the precise form disclosed.

Various Analyses and Evaluation of Physical Properties for Polymers Prepared were Carried Out According to the Following Methods:
1. Hydrogenation conversion of the conjugated diene polymer was measured with IR and calculated by formulas as follows:

cis % (before or after hydrogenation)=cis-double bonds (before hydrogenation or residuals after hydrogenation)/total double bonds (before hydrogenation)×100%;

vinyl % (before or after hydrogenation)=vinyl-double bonds (before hydrogenation or residuals after hydrogenation)/total double bonds (before hydrogenation)×100%;

trans % (before or after hydrogenation)=trans-double bonds (before hydrogenation or residuals after hydrogenation)/total double bonds (before hydrogenation)×100%;

hydrogenation conversion(%)=100%−cis % (residuals after hydrogenation)−vinyl % (residuals after hydrogenation)−trans % (residuals after hydrogenation).
2. Thermal stability (color) and odor of the hydrogenated conjugated diene polymer: The color were determined by observing color thereof after heated in an oven at 180° C. for 3 hours.

### Preparative Example

### Preparation of a Conjugated Diene Polymer

In Examples of the present invention, the conjugated diene polymer was linear styrene-butadiene-styrene (SBS) block copolymers having a number average molecular weight 160,000, which was prepared by steps of: (a) cyclohexane (110 kg), n-butyl lithium (n-BuLi, 8.0%, 120 g), tetra methyl ethylene diamine (TMEDA, 8.0 g) and styrene (2.6 kg) were charged in 200 L of a nitrogen-sealed reactor equipped with a jacket and a stirrer, then, (b) butadiene (11.8 kg) were added; then, (c) styrene (2.6 kg) were added to the reaction system and the reaction mixtures was polymerized to obtain a conjugated diene polymer solution (solid content is 13.5 wt. %).

### Example 1

After preparation of the conjugated diene polymer solution, the hydrogen (with a pressure of 5 kg/cm²) was introduced into the reactor to replace nitrogen. To prepare solutions containing individual components of the catalyst composition for hydrogenation, bis(cyclopentadienyl) titanium dichloride (Cp₂TiCl₂) was dissolved in cyclohexane to form a solution (0.12 wt. %), polymethylhydrosiloxane was dissolved in cyclohexane to form a solution (0.75 wt. %), titanium(IV) isopropoxide (TPT) was dissolved in cyclohexane to form a solution (0.2 wt. %) and n-butyl lithium (n-BuLi) was dissolved in cyclohexane to form a solution (8 wt. %).

The above solution of individual components were added into the reactor according to the dosages listed in Table 1. The hydrogenation reaction was controlled at a temperature of 75° C., a pressure of 5 kg/cm² for 8 hours. The hydrogenated conjugated diene polymer of the present invention was then obtained. The catalyst composition for hydrogenation and operation conditions for hydrogenation of Example 1 were listed in Table 1. Hydrogenation conversion and residual trans % (after hydrogenation) of the hydrogenated conjugated diene polymer were listed in Table 3. The hydrogenated conjugated diene polymer was odorless, and presents little yellow color after the test of thermal stability.

### Examples 2˜11

The same procedures described in Example 1 were repeated according to Table 1. Hydrogenation conversion and residual trans % (after hydrogenation) of the hydrogenated conjugated diene polymer were listed in Table 3. The hydrogenated conjugated diene polymer obtained in Examples 2˜11 were odorless, and those obtained in Examples 2˜11 presented little yellow color in the test of thermal stability.

### Comparative Example 1

The conjugated diene polymer was prepared from the preparative example, the hydrogen (with a pressure of 5 kg/cm²) was introduced into the reactor to replace nitrogen. To prepare solutions containing individual components of the catalyst composition for hydrogenation, bis(cyclopentadienyl) titanium dichloride (Cp₂TiCl₂) was dissolved in cyclohexane to form a solution (0.12 wt. %), polymethylhydrosiloxane was dissolved in cyclohexane to form a solution (0.75 wt. %) and n-butyl lithium(n-BuLi) was dissolved in cyclohexane to form a solution (8 wt. %). The above solution of individual components were added into the reactor according to the dosages listed in Table 2. The hydrogenation reaction was controlled at a temperature of 75° C., a pressure of 5 kg/cm² for 8 hours. The catalyst composition for hydrogenation and operation conditions for hydrogenation of Comparative Example 1 were listed in Table 2. Hydrogenation conversion and residual trans % (after hydrogenation) of the hydrogenated conjugated diene polymer were listed in Table 4. The hydrogenated conjugated diene polymer was odorless, and presented yellow-to-brown color in the test of thermal stability.

### Comparative Examples 2˜3

The same procedures described in the Example 1 were repeated according to dosages and operation conditions as listed in Table 2. Hydrogenation conversion and residual trans % (after hydrogenation) of the hydrogenated conjugated diene polymer were listed in Table 4.

### Comparative Example 4

The same procedures described in Example 1 were repeated according to dosages and operation conditions as listed in Table 2. Hydrogenation conversion and residual trans % (after hydrogenation) of the hydrogenated conjugated diene polymer were listed in Table 4. The hydrogenated conjugated diene polymer has a strong unpleasant odor, and presented dark brown color in the test of thermal stability.

As shown in the results of the Comparative Examples 1˜3 in which the catalyst compositions without component (C) were used for hydrogenation carried out in a middle or large sized reactor (25 liters or larger), activities of the catalysts were low, satisfactory hydrogenation conversion (for example, over 90%) could not be achieved, and particularly the residual trans structures in the hydrogenated conjugated diene polymers remained more. In addition, the result of Comparative Example 1 showed the hydrogenated conjugated diene polymer with poor thermal stability.

In the Comparative Example 4, the catalyst composition including Cp₂TiCl₂, TPT and triisobutyl aluminum had poor activity when applied in a middle or large sized reactor (25 liters or larger), and therefore the hydrogenation conversion of the conjugated diene polymer was low. Particularly, the hydrogenated conjugated diene polymer had a lot of residual trans structure, and presented poor thermal stability and strong unpleasant odor.

As for Examples 1˜11, the catalyst composition of the present invention comprised a titanium compound (A), a silyl hydride (B) and a compound (C), and/or a compound (D) performs superior activity in the middle or large sized reactor (25 liters or larger), and hydrogenated conversion of the conjugated diene polymer could achieve higher than 90%. Particularly, the hydrogenated conjugated diene polymer contained little residual trans structures. The present invention indeed provided a better catalyst composition without organic aluminum compound for hydrogenation of polymers with better hydrogenation conversion, thermal stability, weather resistance and lower cost, that is, more economical efficiency then the prior art. In addition, the hydrogenated conjugated diene polymer of the present invention was thermally stable and odorless.

The foregoing description of the preferred embodiments of the invention has been presented for purposes of illustration and description. Obvious modifications or variations are possible in light of the above teaching. The embodiments were chosen and described to provide a good illustration of this invention and its practical application to thereby enable those skilled in the art to utilize the invention in various embodiments and with various modifications as are suited to the particular use contemplated. All Such modifications and variations are within the scope of the present invention as determined by the appended claims when interpreted in accordance with the breadth to which they are fairly, legally, and equitably entitled.

TABLE 1
Components and their dosages used for the catalyst compositions and operation conditions of Examples 1~11

| | | | | | | | | | | | (C)/(B) | Compound (D) | |
|---|---|---|---|---|---|---|---|---|---|---|---|---|---|
| | T | P | Compound (A) | | Compound (B) | | (B)/(A) | Compound (C) | | (C)/(A) | Mole | Alkyl metal | |
| Examples | (° C.) | (kg/cm2) | Species | Mole | Species | Mole | Mole ratio | Species | Mole | Mole ratio | ratio | Species | Mole |
| 1 | 75 | 5 | Cp₂TiCl₂ | 0.0052 | PMHS | 0.001 | 0.19 | TPT | 0.083 | 1.6 | 83 | nBuLi | 0.05 |
| 2 | 75 | 5 | Cp₂TiCl₂ | 0.0052 | PMHS | 0.001 | 0.19 | TPT | 0.014 | 2.7 | 14 | nBuLi | 0 |
| 3 | 75 | 5 | Cp₂TiCl₂ | 0.0052 | PMHS | 0.001 | 0.19 | TnBT | 0.02 | 3.9 | 20 | nBuLi | 0.05 |
| 4 | 90 | 5 | Cp₂TiCl₂ | 0.0052 | PMHS | 0.001 | 0.19 | TnBT | 0.014 | 2.7 | 14 | nBuLi | 0.05 |
| 5 | 90 | 5 | Cp₂TiCl₂ | 0.0052 | PMHS | 0.001 | 0.19 | TnBT | 0.02 | 4 | 20 | nBuLi | 0.05 |
| 6 | 90 | 7 | Cp₂TiCl₂ | 0.0052 | PMHS | 0.001 | 0.19 | TnBT | 0.014 | 2.7 | 14 | nBuLi | 0 |
| 7 | 85 | 5 | Cp₂TiCl₂ | 0.0052 | PMHS | 0.001 | 0.19 | TnBT | 0.014 | 2.7 | 14 | nBuLi | 0.05 |
| 8 | 85 | 5 | Cp₂TiCl₂ | 0.0052 | DMPS | 0.0027 | 0.52 | TnBT | 0.014 | 2.7 | 5.2 | nBuLi | 0.05 |
| 9 | 85 | 5 | Cp₂TiCl₂ | 0.0052 | MHCS | 0.007 | 1.34 | TnBT | 0.014 | 2.7 | 2 | nBuLi | 0.05 |
| 10 | 75 | 5 | Cp₂TiMe₂ | 0.0052 | PMHS | 0.001 | 0.19 | TnBT | 0.014 | 2.7 | 14 | nBuLi | 0.05 |
| 11 | 75 | 5 | Cp₂TiCl₂ | 0.0052 | PMHS | 0.001 | 0.19 | TnBT | 0.014 | 2.7 | 14 | nBuLi | 0.05 |

PMHS: polymethylhydrosiloxane
DMPS: dimethyl phenyl siloxane
MHCS: methylhydrocyclosiloxane
TPT: titanium(IV) isopropoxide
TnBT: TnBT: titanium(IV)n-butoxide
nBuLi: n-butyl lithium
Cp₂TiCl₂: bis(cyclopentadienyl) titanium dichloride
Cp₂TiMe₂: bis(cyclopentadienyl) titanium dimethyl

TABLE 2
Components and their dosages used for the catalyst compositions and operation conditions
of Comparative Examples 1~4

| | | | Compound | | Compound | | (B)/(A) | Compound | | (C)/(A) | (C)/(B) | Compound (D) | |
|---|---|---|---|---|---|---|---|---|---|---|---|---|---|
| Comparative | T | P | (A) | | (B) | | Mole | (C) | | Mole | Mole | Alkyl metal | |
| Examples | (° C.) | (kg/cm²) | Species | Mole | Species | Mole | ratio | Species | Mole | ratio | ratio | Species | Mole |
| 1 | 75 | 5 | Cp₂TiCl₂ | 0.0052 | PMHS | 0.001 | 0.19 | — | — | — | — | nBuLi | 0.05 |
| 2 | 90 | 5 | Cp₂TiCl₂ | 0.0052 | PMHS | 0.001 | 0.19 | — | — | — | — | nBuLi | 0.05 |
| 3 | 75 | 5 | Cp₂TiMe₂ | 0.0052 | PMHS | 0.001 | 0.19 | — | — | — | — | nBuLi | 0.05 |
| 4 | 75 | 5 | Cp₂TiCl₂ | 0.0085 | — | — | — | TPT | 0.017 | 2 | — | TiBA | 7 |

PMHS: polymethylhydrosiloxane
nBuLi: n-butyl lithium
TiBA: triisobutyl aluminum
Cp₂TiCl₂: bis(cyclopentadienyl) titanium dichloride
Cp₂TiMe₂: bis(cyclopentadienyl) titanium dimethyl
TPT: titanium(IV) isopropoxide

TABLE 3
Structures of conjugated diene polymers (before hydrogenation) and
residual trans structures (after hydrogenation), and hydrogenation
conversion of the hydrogenated conjugated diene polymers of Examples
1~11

| | | | | | | | Hydro- |
|---|---|---|---|---|---|---|---|
| | Before | | | After | | | genation |
| Exam- | hydrogenation (%) | | | hydrogenation (%) | | | conversion |
| ples | cis % | vinyl % | tran % | cis % | vinyl % | tran % | (%) |
| 1 | 26.06 | 43.91 | 30.03 | 0.49 | 1.25 | 2.12 | 96.1 |
| 2 | 26.97 | 43.06 | 29.97 | 0.48 | 1.14 | 1.93 | 96.5 |
| 3 | 24.82 | 44.63 | 30.55 | 0.33 | 1.39 | 1.08 | 97.2 |
| 4 | 27.04 | 41.15 | 31.81 | 0.55 | 0.95 | 3.30 | 95.2 |
| 5 | 27.23 | 40.76 | 32.01 | 0.2 | 0.6 | 1.1 | 98.2 |
| 6 | 26.46 | 41.44 | 32.1 | 0.29 | 0.68 | 1.44 | 97.6 |
| 7 | 28.2 | 40.81 | 30.98 | 0.15 | 0.37 | 0.55 | 98.9 |
| 8 | 26.65 | 43.22 | 30.13 | 0.36 | 0.85 | 1.29 | 97.5 |
| 9 | 26.39 | 43.35 | 30.26 | 0.43 | 1.03 | 1.74 | 96.8 |
| 10 | 27.08 | 41.53 | 31.38 | 0.40 | 0.96 | 1.44 | 97.2 |
| 11 | 27.91 | 40.38 | 31.71 | 0.45 | 1.14 | 1.27 | 97.1 |

cis %: cis structure; vinyl %: vinyl structure; tran %: trans structure

TABLE 4
Structures of conjugated diene polymers (before hydrogenation) and
residual trans structures (after hydrogenation), and hydrogenation
conversion of the hydrogenated conjugated diene polymers of Comparative
Examples 1~4

| | Before | | | After | | | Hydro- |
|---|---|---|---|---|---|---|---|
| | hydrogenation (%) | | | hydrogenation (%) | | | genation |
| Comparative | | vinyl | | | | Tran | conversion |
| Examples | cis % | % | tran % | cis % | vinyl % | % | (%) |
| 1 | 26.63 | 41.75 | 31.62 | 1.60 | 2.18 | 14.62 | 81.6 |
| 2 | 26.78 | 42.33 | 30.89 | 2.39 | 3.26 | 21.85 | 72.5 |
| 3 | 26.82 | 41.63 | 31.54 | 1.75 | 2.39 | 16.05 | 79.8 |
| 4 | 24.36 | 46.31 | 29.34 | 1.60 | 2.47 | 18.68 | 77.3 |

cis %: cis structure; vinyl %: vinyl structure; tran %: trans structure

What is claimed is:

1. A process for hydrogenation of a conjugated diene polymer comprising hydrogenating said polymer in the presence of hydrogen and:
(I) a hydrogenation catalyst composition, wherein the catalyst composition comprising:
(1) a titanium compound (A) represented by the following formula (a): 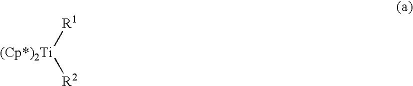
wherein R¹ and R², which may be the same or different, represent a halogen atom, an alkyl group, an aryl group, an arakyl group, a cycloalkyl group, an aryloxy group, an alkoxy group or a carbonyl group, and Cp* represents a cyclopentadienyl group or a derivative having the formula of C₅R³₅, and R³, which may be the same or different, represents a hydrogen atom;
(2) a silyl hydride (B) selected from the group having a Si—H group and consisting of:
(i) a monomeric silyl hydride represented by the following formula (b): 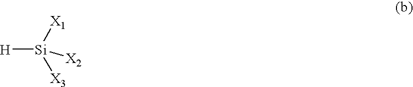
wherein X₁, X₂ and X₃ which may be the same or different, represent a hydrogen atom, a halogen atom, an alkyl group, an aryl group, an aralkyl group, a cycloalkyl group, an aryloxy group, an alkoxy group, an acyloxy group or a carboxylate group,
(ii) a polymeric silyl hydride represented by the following formula (c): 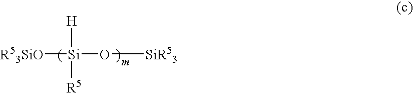
wherein each R⁵ can be the same or different and is selected from the group consisting of a hydrogen atom, a halogen atom, an alkyl group, an aryl group, an aralkyl group, a cycloalkyl group, an aryloxy group and an alkoxy group and m>0;
(iii) a cyclic silyl hydride represented by the following formula (d): 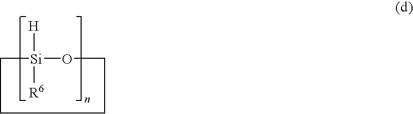
wherein R⁶ represent a hydrogen atom, a halogen atom, an alkyl group, an aryl group, an aralkyl group, a cycloalkyl group, an aryloxy group or an alkoxy group and n=2, 3, 4 or 5; and
(3) a compound (C) represented by the following formula (e): 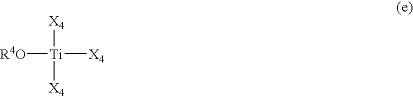
wherein R⁴ is an alkyl group of C₁˜C₁₂ or a cycloalkyl group of C₁˜C₁₂, X₄ can be the same or different and is an alkyl group of C₁˜C₁₂, an alkoxy group of C₁˜C₁₂, cycloalkoxy group of C₁˜C₁₂, a halogen atom or a carbonyl group, and conducting the hydrogenation in
(II) a middle to large sized reactor having a capacity of 25 liters or larger, with
(III) a temperature of 50° C.˜150° C., and
(IV) a hydrogen pressure of 1 kg/cm²˜20 kg/cm².

2. The process for hydrogenation of the conjugated diene polymer as claimed in claim 1, wherein the hydrogen pressure is controlled within 1 kg/cm²˜12 kg/cm².

3. The process for hydrogenation of the conjugated diene polymer as claimed in claim 1, wherein the hydrogenation conversion of the conjugated diene polymer at least 90%.

4. The process for hydrogenation of the conjugated diene polymer as claimed in claim 1, wherein the reactor is selected from stirred tank reactors, loop-reactors, or packing-tower reactors.

5. The process for hydrogenation of the conjugated diene polymer as claimed in claim 1, wherein the hydrogenation catalyst composition further comprising a metal compound (D).

6. The process for hydrogenation of the conjugated diene polymer as claimed in claim 5, wherein the metal compound (D) is an organic lithium compound.

7. The process for hydrogenation of the conjugated diene polymer as claimed in claim 1, wherein Cp* of the formula (a) is cyclopentadienyl.

8. The process for hydrogenation of the conjugated diene polymer as claimed in claim 1, wherein the titanium compound (A) is selected from the group consisting of bis(cyclopentadienyl) titanium dichloride, bis(cyclopentadienyl) titanium dibromide, bis(cyclopentadienyl) titanium diiodide, bis(cyclopentadienyl) titanium difluoride, bis(cyclopentadieniyl) titanium dicarbonyl, bis(cyclopentadienyl) titanium dimethyl, bis(cyclopentadienyl) titanium diethyl, bis(cyclopentadienyl) titanium dipropyl (including isopropyl), bis(cyclopentadienyl) titanium isopropyl, bis(cyclopentadienyl) titanium dibutyl, bis(cyclopentadienyl) titanium n-butyl, bis(cyclopentadienyl) titanium sec-butyl, bis(cyclopentadienyl) titanium tert-butyl, bis(cyclopentadienyl) titanium dibenzyl, bis(cyclopentadienyl) titanium diphenyl, bis(cyclopentadienyl) titanium dimethoxide, bis(cyclopentadienyl) titanium diethoxide, bis(cyclopentadienyl) titanium dipropoxide, bis(cyclopentadienyl) titanium dibutoxide, bis(cyclopentadienyl) titanium diphenoxide, bis(cyclopentadienyl) titanium methyl chloride, bis(cyclopentadienyl) titanium methyl bromide, bis(cyclopentadienyl) titaniumn methyl iodide, bis(cyclopentadienyl) titanium methyl fluoride, and a mixture thereof.

9. The process for hydrogenation of the conjugated diene polymer as claimed in claim 1, wherein the monomeric silyl hydride is selected from the group consisting of methyl dichlorosilane, ethyl dichlorosilane, propyl dichlorosilane, butyl dichlorosilane, phenyl dichlorosilane, dimethyl chlorosilane, diethyl chlorosilane, dipropyl chlorosilane, dibutyl chlorosilane, diphenyl chlorosilane, dimethyl methoxy silane, dimethyl ethoxy silane, dimethyl propoxy silane, dimethyl butoxy silane, dimethyl benzoxy silane, diethyl ethoxy silane, diethyl ethoxy silane, diethyl propoxy silane, diethyl butoxy silane, diethyl benzoxy silane, dipropyl methoxy silane, dipropyl ethoxy silane, dipropyl propoxy silane, dipropyl butoxy silane, dipropyl benzoxy silane, dibutyl methoxy silane, dibutyl ethoxy silane, dibutyl propoxy silane, dibutyl butoxy silane, dibutyl benzoxy silane, diphenyl methoxy silane, diphenyl ethoxy silane, diphenyl propoxy silane, diphenyl butoxy silane, diphenyl benzoxy silane, dimethylsilane, diethylsilane, dipropylsilane, dibutylsilane, diphenylsilane, diphenylmethylsilane, diphenylethylsilane, diphenylpropylsilane, diphenylbutylsilane, trimethylsilane, triethylsilane, tripropylsilane, tributylsilane, triphenylsilane, methylsilane, ethylsilane, propylsilane, butylsilane, phenylsilane and methyldiacetoxysilane.

10. The process for hydrogenation of the conjugated diene polymer as claimed in claim 1, wherein the titanium compound (A) has a concentration ranging from 0.0002 millimoles to 20 millimoles per 100 g of polymers to be hydrogenated.

11. The process for hydrogenation of the conjugated diene polymer as claimed in claim 1, wherein the silyl hydride (B) to the titanium (A) has a mole ratio within ranges from 0.01 to 200.

12. The process for hydrogenation of the conjugated diene polymer as claimed in claim 1, wherein the compound (C) to the titanium compound (A) has a mole ratio within ranges from 0.01 to 50.

13. The process for hydrogenation of the conjugated diene polymer as claimed in claim 1, wherein the conjugated diene polymer has a number average molecular weight ranging from 500 to 1,000,000.

14. The process for hydrogenation of the conjugated diene polymer as claimed in claim 1, wherein the conjugated diene polymer comprises homopolymers or copolymers of 1,3-butadiene and/or isoprene.
